(19) United States
(12) Patent Application Publication
(10) Pub. No.: US 2014/0351155 A1
(43) Pub. Date: Nov. 27, 2014

(54) AUTOMATED EMPLOYEE SATISFACTION PREDICTOR

(71) Applicant: Rawlin International Inc., Tortola (VG)

(72) Inventor: Andrey N. Nikankin, Sankt-Peterburg (RU)

(73) Assignee: Rawlin International Inc., Tortola (VG)

(21) Appl. No.: 13/899,380

(22) Filed: May 21, 2013

(51) Int. Cl. G06Q 10/10

(52) U.S. Cl. CPC G06Q 10/105
USPC 705/320

(57) ABSTRACT

Employee satisfaction and the possibility of an employee job change are predicted. Data can be collected related to employee internet usage, employee mobile device telecom usage, employee human resource data, or employee demographic data. By analyzing this collection data, employees that are satisfied or dissatisfied can be identified. In addition, it can also be determined how likely an employee is to make a job change.

### TECHNICAL FIELD

This application generally relates to human resources, e.g., to automated generation of an employee satisfaction predictor.

### BACKGROUND

Businesses invest substantial sums of money in the hiring and training of new workers. Even before a prospective employee is hired, substantial sums of money can be spent in advertising an opening, hiring recruiters, conducting interviews, conducting drug screenings, conducting background checks, etc. In addition, during the hiring process, current employees may have to take valuable time away from their core job duties, further adding to the costs associated with hiring new workers. Training costs can also be significant. Hard costs such as training videos, training sessions, educational sessions, salaries trainers, etc. are present in many job training situations. Employee time for managers and key coworkers is also often times required during job training, reducing those managers and key coworkers productivity on other tasks during the training. Losses in efficiency can also be present since, depending on the nature of the position being hired, new employees may be far less productive than current employees doing the same job.

While costs associated with the hiring and training of new personnel can be significant, often employers don't have a choice as a former employee's decision to leave their employment forces the employer to hire a replacement. Acknowledging these costs, it may be more advantageous for an employer to spend more money in providing additional compensation or other benefits to an employee who is considering leaving the company as a means to retain that employee rather than hiring a replacement. However, employees rarely disclose that they are leaving a company for a position at a different company or even considering leaving the company, until after the employee has made their decision on whether to leave. For the avoidance of doubt, the above-described contextual background shall not be considered limiting on any of the below-described embodiments, as described in more detail below.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

Various embodiments disclosed herein relate to automated employee satisfaction predictor. An internet monitoring component can monitor internet usage data associated with internet usage of an employee and generate employee internet profile data representative of an internet profile of the employee based on a result of the internet usage data being monitored. A mobile device monitoring component can monitor mobile communication data representative of communications associated with a mobile device of the employee and generate employee mobile device profile data representative of an employee mobile device profile based on a result of the mobile communication data being monitored. A human resources data component can generate employee human resource profile data representative of a human resource profile of the employee based on job description data representative of a job description of the employee, attendance record data representative of an attendance record of the employee, and compensation profile data representative of a compensation profile of the employee. An employee satisfaction component can determine employee job satisfaction data representative of a job satisfaction of the employee based on the employee internet profile data, the employee mobile device profile data, and the employee human resource profile data.

In another embodiment, a method is established for receiving, by a system including a processor, internet history data indicative of an internet history associated with an employee wherein the internet history data comprises social networking post data, web site history data, application access data, employer e-mail volume data, and personal e-mail volume data. The method further provides for receiving mobile device data representative of communications associated with a mobile device of the employee wherein the mobile device data comprises a first set of phone calls using the mobile device, a second set of text messages using the mobile device, or location log data representative of past locations of the mobile device. The method then provides for receiving an employee human resource profile data representative of a human resource profile of the employee based on job description data representative of a job description of the employee, attendance record data representative of an attendance record of the employee. Finally, the method provides for generating an employment satisfaction rating representative of an employment satisfaction of the employee based on the set of internet history data, the mobile device data, and the employee human resource profile data.

In another embodiment, a computer-readable storage medium comprising computer-executable instructions that, in response to execution, can cause a computing system comprising a processor to perform operations. Internet history data indicative of an internet history associated with an employee can be received wherein the internet history data comprises social networking post data, web site history data, application access data, employer e-mail volume data, and personal e-mail volume data. Mobile device data representative of communications associated with a mobile device of the employee can be received wherein the mobile device data comprises a first set of phone calls using the mobile device, a second set of text messages using the mobile device, or location log data representative of past locations of the mobile device. An employee human resource profile data representative of a human resource profile of the employee can be received wherein the employee human resource profile is based on job description data representative of a job description of the employee, attendance record data representative of an attendance record of the employee, and compensation profile data representative of a compensation profile of the employee. Demographic profile data representative of a demographic profile of the employee can be received wherein the demographic profile data is based on at least one of a home purchase date associated with the employee, a residence change date associated with the employee, a set of child birth dates associated with the employee, a marriage date associated with the employee, a credit report value associated with the employee, or an employee birth date associated with the employee. An employment satisfaction rating representative of an employment satisfaction of the employee can be generated based on the set of internet history data, the mobile device data, the employee human resource profile data; and the demographic profile data

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates example flow diagram for predicting an employee satisfaction index and a possible job change index;

FIG. 2 illustrates an example diagram of internet data that can be collected and incorporated into an employee satisfaction index and/or a possible job change index;

FIG. 3 illustrates an example diagram of mobile device and telecommunications data that can be collected and incorporated into an employee satisfaction index and/or a possible job change index;

FIG. 4 illustrates an example diagram of demographic data that can be collected and incorporated into an employee satisfaction index and/or a possible job change index;

FIG. 5 illustrates an example diagram of human resource data that can be collected and incorporated into an employee satisfaction index and/or a possible job change index;

FIG. 6 illustrates an example system in accordance with implementations of this disclosure;

FIG. 7 illustrates an example system including a demographic component in accordance with implementations of this disclosure;

FIG. 8 illustrates an example flow diagram method for generating an employment satisfaction rating in accordance with implementations of this disclosure;

FIG. 9 illustrates an example flow diagram method for generating an employment satisfaction including generating an intensity of resume update index in accordance with implementations of this disclosure;

FIG. 10 illustrates an example flow diagram method for generating an employment satisfaction rating including generating a call volume index in accordance with implementations of this disclosure;

FIG. 11 illustrates an example flow diagram method for generating an employment satisfaction rating including generating an internet job search index in accordance with implementations of this disclosure;

FIG. 12 illustrates an example flow diagram method for generating an employment satisfaction rating including generating a geographical index in accordance with implementations of this disclosure;

FIG. 13 illustrates an example flow diagram method for generating an employment satisfaction rating including generating a possible job change index in accordance with implementations of this disclosure;

FIG. 14 illustrates an example block diagram of a computer operable to execute the disclosed architecture; and

FIG. 15 illustrates an example schematic block diagram for a computing environment in accordance with the subject specification.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the various embodiments.

Costs associated with the hiring and training of employees can be substantial. While direct costs such as interviewer time, recruitment expenses, and training can be more easily quantified, soft costs such as loss of productivity can also affect an employer's bottom line. While an employee may take a position with another company for reasons outside the employer's control, some employees may choose to leave employment for reasons that an employer can control. For example, an employee who seeks new employment due to issues related to salary, benefits, or job duties, may be content to remain with their current employer if these issues are addressed. While many employer-employee relationships provide for annual reviews or other performance reviews that allow an employee to voice their dissatisfaction regarding their current employment situation, employees may not be truthful or offer full disclosure for a variety of reasons. If an employer can assess the costs associated with hiring and training a replacement worker for a current employee that is considering leaving employment, it may be advantageous for the employer to address the employee's needs, even with added cost, rather than investing in a new employee.

In addition to retaining employees as a means to save costs, having knowledge related to job satisfaction and the potential of the employee to leave for a job change can help mitigate costs associated with hiring a replacement if the employer-employee relationship cannot be salvaged. For example, an employer can get a head start on the recruitment and interview stages in selecting a replacement providing for a reduced length of transition between the exiting employee and the new employee.

In another example, the benefits associated with understanding employee job satisfaction exist outside mitigating the costs of hiring replacement employees. Employers with widespread employee dissension can address job satisfaction Issues Company wide. It can be appreciated that employees, who feel that their job satisfaction issues are being addressed, may be motivated to work harder and consequentially increase productivity.

Various embodiments disclosed herein relate to prediction of employee satisfaction and the possibility of an employee job change. Data can be collected related to employee internet usage, employee mobile device telecom usage, employee human resource data, or demographic data. By analyzing this data, employees that are satisfied or dissatisfied can be identified. In addition, it can also be determined how likely an employee is to make a job change.

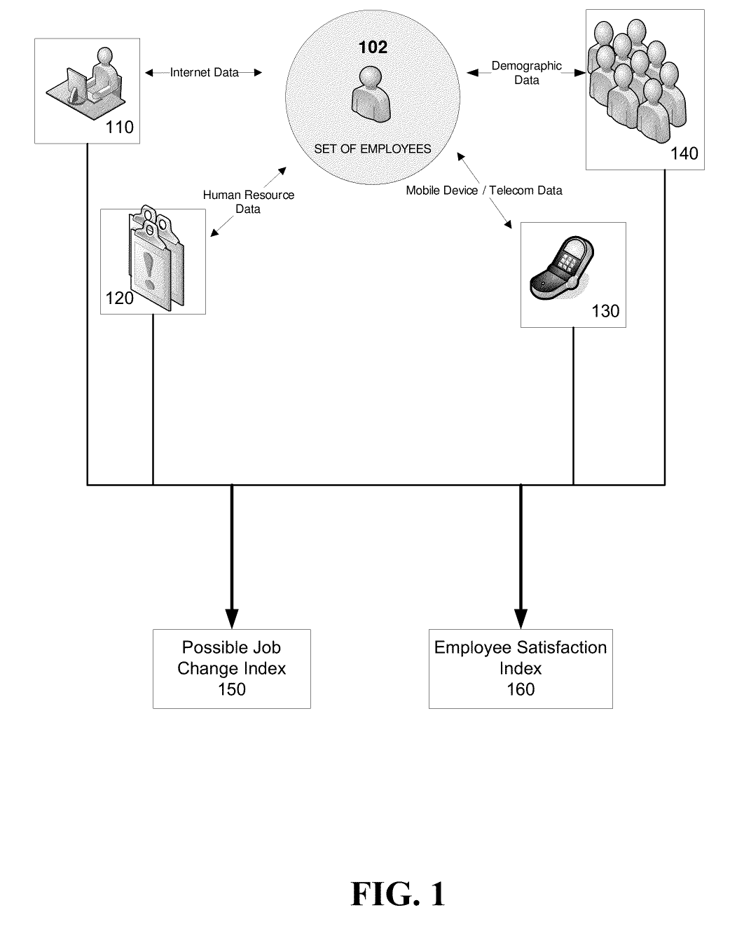

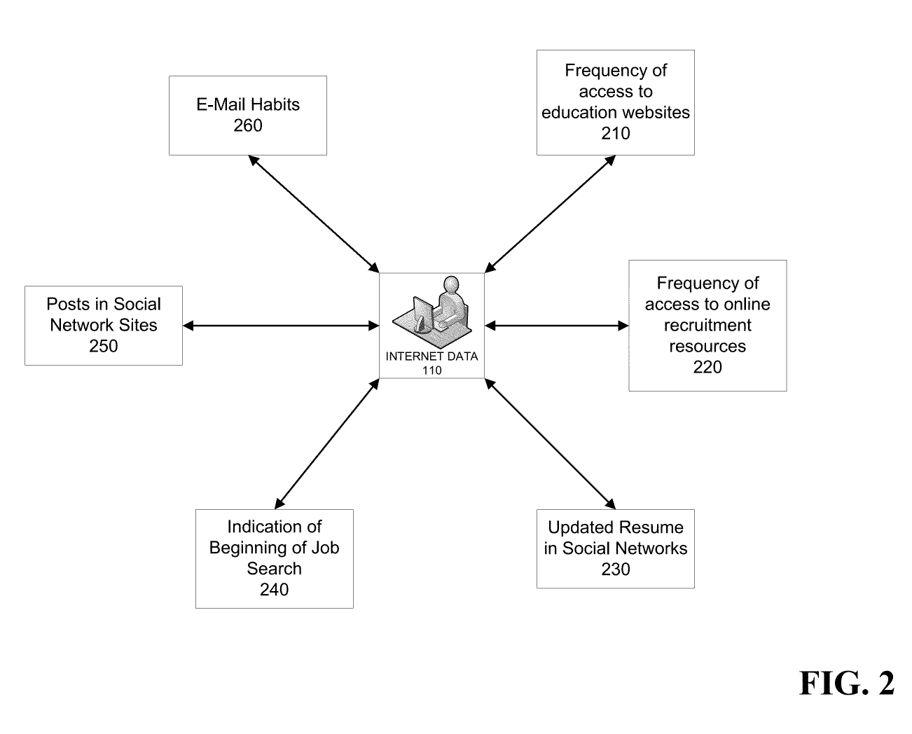

Referring to FIG. 1, there is illustrated an example flow diagram for predicting an employee satisfaction index and a possible job change index. A set of employees 102, can have data collected based on their actions. Internet data 110 can be collected based on individual employees in the set of employees 102. For example, any time an employee logs in to an employer computer network and accesses the internet, data can be collected on what sites were accessed, how many times sites were accessed, and how long sites remained open. It can be appreciated that cookies can be used to trace what parts of the internet employees are accessing. In addition, for a remote employee that accesses corporate internet resources via an internet connection, those connections can also be monitored, when active, to determine internet data. It can be appreciated that data can be collected for all employees or a subset of employees employed by the employer. For example, as discussed in greater detail with regard to FIG. 2, an example of internet data tracked can be the amount of times an employee is accessing online recruitment resources. In this example, it may be not be useful to determine the amount of times a human resource employee is accessing online recruitment resources as that access may be a part of that employee's job description.

In addition to monitoring employee access to the internet, employee social network sites can be monitored as well. For example, an employee may update a social networking site with a post regarding their desire to seek new employment. While that post, made outside of the employer's computer network, cannot be traced using cookies from the employer computer network, public posts on social networks can still be accessed by the employer. In addition, an employer may have a lawful right, or an employee may agree to allow the employer, to monitor otherwise private social networking posts.

Human resource data 120 can also be collected related to the set of employees 102. Human resource data can include payroll data, insurance and benefit data, vacation day and sick day use, hourly work logs, productivity logs, etc.

Mobile device and telecommunications data 130 can also be collected related to the set of employees 102. For example, any calls made using a landline of the employer can be traced to determine the identity of the employee and the outside caller. The length of time the employee was on the phone for each call can also be tracked. In another example, an employer provided mobile device capable of placing phone calls can be monitored for the same information, as well as for incoming and outgoing SMS messages, mobile device internet data (which can be incorporated into internet data 110), mobile device GPS data, etc. In still other instances, an employer may monitor an employee's personal mobile device or home phone subject to privacy laws and employer/employee contractual agreements.

Demographic data 140 can also be collected related to the set of employees 102. For example, demographic information related to the employee can be collected from tax forms, public records, credit reports, background checks, etc.

From the collected internet data 110, human resource data 120, mobile device and telecommunications data 130, and demographic data 140, a possible job change index 150 and/or an employee satisfaction index 160 can be generated. It can be appreciated that not all forms of data will be available for every employee. For example, an employee on an assembly line may not have an employee telephone or mobile device and correlating mobile device and telecommunications data 130. FIGS. 2-5 illustrate in greater detail the individual types of data collected under the four umbrella categories as shown on FIG. 1 (e.g., internet data 110, human resource data 120, mobile device and telecommunications data 130, and demographic data 140).

Referring to FIG. 2, there is illustrated an example diagram of internet data 110 that can be collected and incorporated into an employee satisfaction index and/or a possible job change index.

One example of internet data that can be collected is the frequency of access to education websites 210. It can be appreciated that not all employees who are dissatisfied with the employment or seeking a potential job change desire a direct next step of new employment. They may instead desire to get further job training through education to change fields or change roles within their existing field. Frequent access to degree program websites may be a sign that an employee is considering leaving employment to start or return to school full time. Both repeated access to a single educational site and low level access to many different educational sites may be indicative of an employee that desires to return to school full time.

Another type of internet data that can be collected is the frequency of access to online recruitment resources 220. For example, an employee logging in to known recruiting websites like Monster.com© or similar sites may be indicating that they are searching for outside employment. As an example calculation, a function can be generated based on the number of days of internet monitoring, the total number of requests to recruitment sites, an average number of requests to recruitment sites over a previous period of days, and an attenuation coefficient of reactive response. For example, the attenuation coefficient of reactive response can be selected based on past results of known responses.

Internet data 110 related to an updated resume in a social networking site 230 can also be collected. For example, social networking sites such as LinkedIn© and Facebook© and the like give users the option to post and/or update a resume or curriculum vitae (“CV”). While posting a new resume may indicate an employee seeking new employment, minor changes such as adding skills, adding example projects, adding developments may also indicate an employee that is dissatisfied with their job and/or desiring a job change. As an example calculation, a function can be generated based on the number of days of internet monitoring, the amount of information included in the main section of the CV, the amount of information included in sections skills/projects/development, and an attenuation coefficient of reactive response.

An indication that an employee is beginning a job search 240 can be collected as internet data 110 as well. Posts in LinkedIn or Moikrug© or other employment related social networking sites can be monitored for an indication of the beginning of a job search. In one example, a function can be generated that reflects the fact of the beginning of the job search that places the employee on a scale between not burdened with finding work and actively looking for work.

Posts in social network sites 250 can be collected as internet data can be relevant in determining employee job satisfaction or a desire for a possible job change. For example, posts related to the employer, the employee's working conditions, or the current location of the employee can be determined to be negative, positive, or unknown. A function can be generated reflecting the amount of positive or negative comments made placing the employee on a scale between a negative job-employer status and a positive job-employer status.

Another example of internet data that can be collected is e-mail habits 260. For example, the amount of outside company e-mail sent using company resources can be monitored. It can be appreciated that employees who are responding to job search inquiries may do so on personal email accounts and thus an increase in volume of personal emails may indicate a dissatisfied employee or an employee seeking a job change. It can be appreciated that events such as bad weather or other personal events may cause the amount of personal e-mail time to fluctuate, so this factor can be augmented by additional data that could negate a spike in traffic. For example, an employee who is having a child, getting married, or undergoing a significant life change of another variety may increase the amount of personal emails sent due to the life change. In addition to personal email being sent, the volume of company email can also be monitored. For example, an employee who averages 100 emails a week using company email as a part of their job duties drops the amount of emails they are sending; it may indicate an apathetic or disengaged employee. These can be symptoms of dissatisfaction or an employee who is changing jobs and is no longer engaged with performing at their previous output.

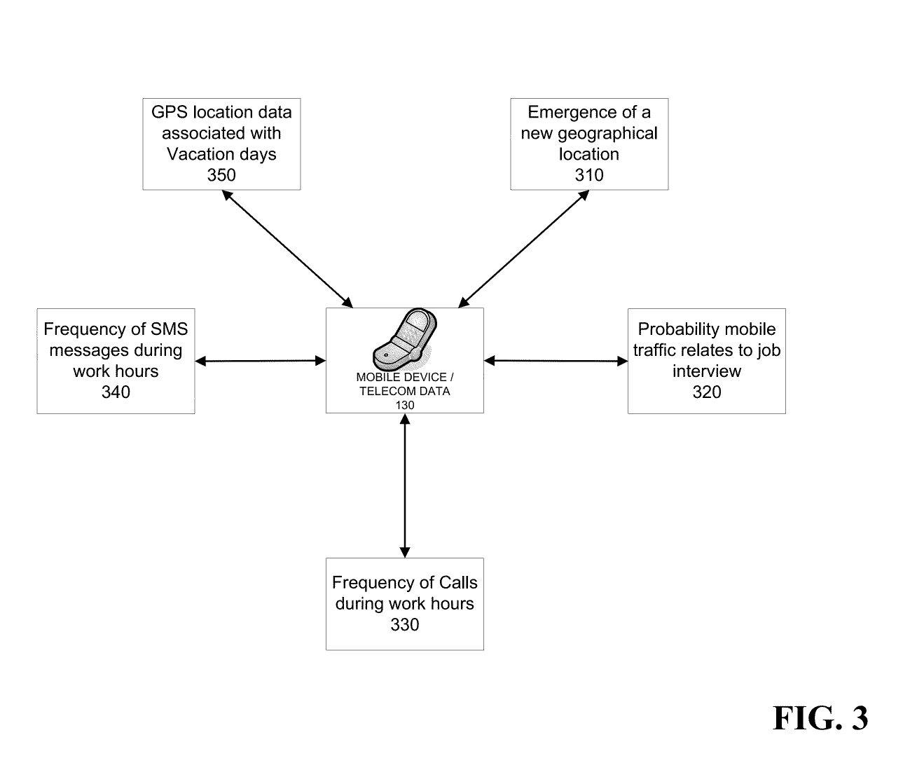

Referring to FIG. 3, there is illustrated an example diagram of mobile device and telecommunications data that can be collected and incorporated into an employee satisfaction index and/or a possible job change index.

One example of mobile device and telecommunications data 130 that can be collected is the emergence of a new geographical location 310. The emergence of a new geographical location can be indicative of interviewing or other job search activities. Geographic clusters can be defined based on real world locations, where an employee whose mobile device travels repeatedly to a cluster may indicate job change activity. Prior to analysis of geographic clusters, in one implementation, a baseline can be established over time of place the employee frequents. Locations then measured later within the baseline can be excluded as potential interview activity. Geographic clusters can exclude locations where the mobile device is moving at a speed greater than travelling speed, for example, 7 kilometers per hour. Geographical clusters that do not coincide with building and structures can also be ruled out as interviews are unlikely to take place outdoors. Locations frequented by business needs can also be excluded. A minimum time spent at the location threshold can also be implemented where an assumption is made that any interview activity would require a certain minimum amount of time period to be accepted as potential interview activity. It can be appreciated the geographic location emerging during work hours may be more significant that outside of work hours as interviewing is more likely to take place during work hours.

The probability mobile traffic relates to job interview 320 can also be collected as mobile device and telecommunications data 130. Using mobile location data collected at 310, additional data can help determine the probability of an interview. For example, an employee who, in succession, establishes new geographical clusters at different companies unrelated to business activities can be indicative of an i9 nteview process. The amount of geographical clusters can also shed light on the amount of interviews that are taking place. For example, if an employee has conducted interviews with four different employers, it can be determined the chances that the employee receives 0, 1, 2, 3 or 4 offers based on the interviewing. A function can be established based on a number of attended interview, a probability of success and a probability of failure. It can be appreciated that probabilities of success and failure respectively can be adjusted depending on the job duties or filed of the employee in question as the more qualified the candidate the more likely they will have fewer interviews during the job search process.

Another example of mobile device and telecommunications data 130 that can be collected is the frequency of calls during work hours 330. For example, a function reflecting the intensity of calls to usual non-business related numbers (relative, friends, acquaintances, etc.) during business hours can be measured. It can be appreciated that an abnormally large number of calls to non-business related numbers may indicate a lack of engagement or other dissatisfaction related to employment. It also may indicate an employee that knows they are soon leaving and is less motivated to perform work tasks. The function can be based on the number of days of monitoring, the number of calls on the day of monitoring, and an average attenuation coefficient of reactive response. It can be appreciated that the exponential attenuation coefficient can reflect that a psychological reaction to a stressful situation generally results in stress and frustration that subsides to half on day 3 and almost completely disappears by day nine. Continued phone calls indicating frustration or stress after this time period may be indicative of employee dissatisfaction

Mobile device and telecommunications data 130 related to the frequency of SMS messages during work hours 340 can also be collected. Similar to phone calls, SMS messages can also be monitored for frequency. In some cases, depending on privacy laws and contractual agreements, the contents of the SMS messages themselves can be analyzed for information indicative of dissatisfaction or a job search. It can be appreciated that a function similar to that described above with respect to monitoring the frequency of phone calls can be established for the frequency of SMS messages.

In addition, GPS location data associated with vacation days 350 can also be collected as mobile device and telecommunications data 130. Employees who do not take vacation may be less satisfied with their working conditions than those that do. It may not be enough to just take vacation days, it is important that the employee actually physically leave their normal geographic location. Similar to the GPS clustering above, a location of occurrences can be determined. The distance between the nearest localization cluster and the GPS coordinates of the employee on their vacation days can be determined. One can then determine the number of days since the employee last left the geographical cluster associated with their normal routine.

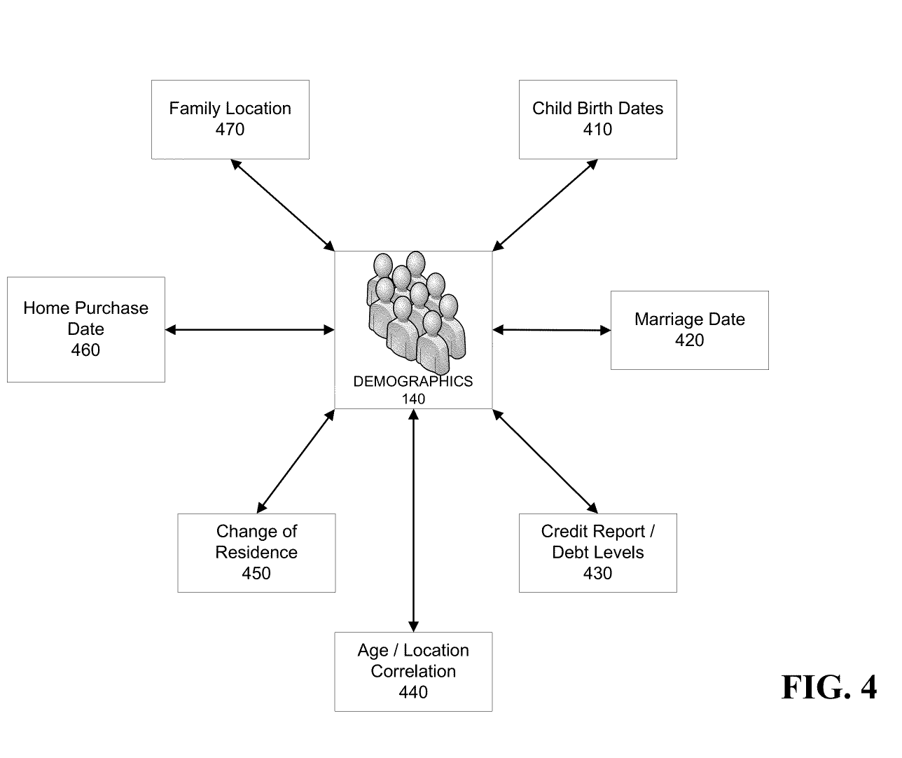

Referring to FIG. 4, there is illustrated an example diagram of demographic data that can be collected and incorporated into an employee satisfaction index and/or a possible job change index. Demographic data can provide context to information gathered above. For example, a child birth date 410 or a marriage date 420 can excuse a large frequency of personal phone calls 340 as they related to a significant life event of the employee. In addition, a credit report that details debt levels 430 may shed light on employees that have a strong financial motivation to seek new employment to make more money.

An age location correlation can be established whereby an employee who falls far outside the typical age range of a company can be flagged as someone more likely to be dissatisfied or seeking a job change. For example, a younger employee in their 20's who works at a location where the average demographic of residents of the location is significantly older, that employee may be more likely to be dissatisfied with their personal life and correspondingly their employment.

Both a change of residence 450 or a home purchase date 460 may indicate an employee has made a commitment to live at a location for at least the short term future. Purchase a home can also be a major financial expenditure, further deterring a person from risking a job change. The location of the home where the employee is moving to or purchased may also confirm an employee's satisfaction (convenient to employer's location) or allude to dissatisfaction (inconvenient to employer's location). An employee's family location 470 can also affect an employee's job satisfaction if employment forces the employee to be too far removed from their family.

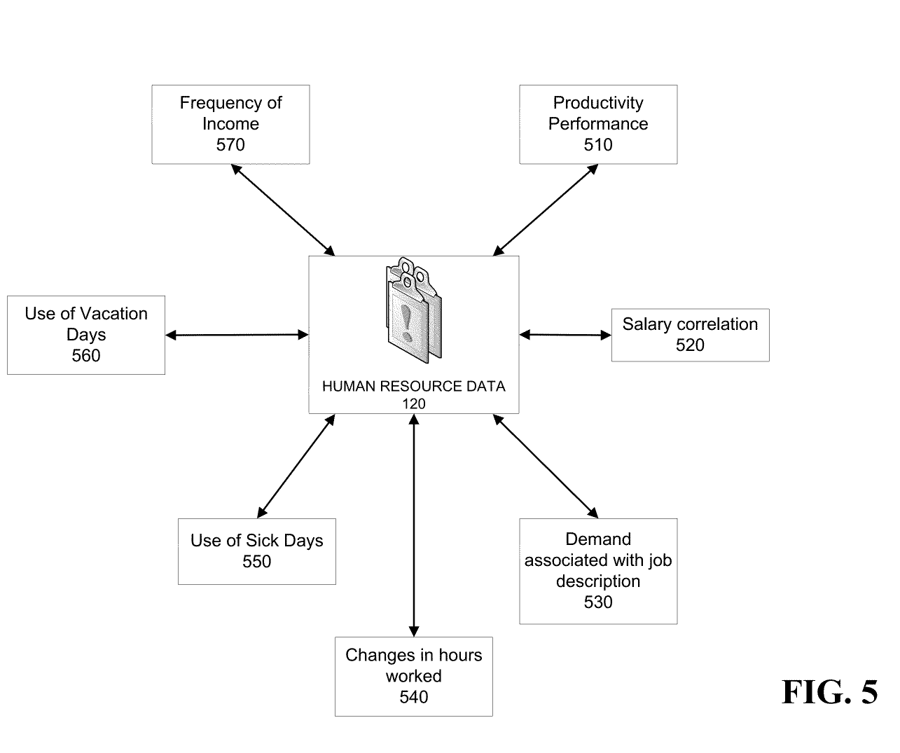

Referring to FIG. 5, there is illustrated an example diagram of human resource data 120 that can be collected and incorporated into an employee satisfaction index and/or a possible job change index. Productivity performance 510 can aggregate performance reviews, annual reviews, quarterly reviews, etc. related to an employee's productivity. It can be appreciated that some employees have reduced productivity right before a job change and they are less engaged knowing their desire for a new a position.

A salary correlation 520 may also indicate satisfaction with employment. Salary correlation can be an assessment of how much money the employee is currently making compared with how much the employee could expect to receive on the open market for the same skill set. An employee who is under compensated in salary, benefits or both may be more likely to be dissatisfied with their employment or seeking a job change.

Demand associated with an employee's job description can indicate whether the employee is more likely to seek a job change. Those employees who have skill-sets that place them in higher demand professions may be more likely to be recruited away. Additionally, those in high demand jobs with low salary correlations 520 may be especially prone to seeking a job change.

Changes in hours worked 540, use of sick days 550, and use of vacation days 560, all related to the amount of time an employee is spending working. An employee that is dissatisfied with employment may use more vacation days, sick days, or other compensation time to work the least amount of hours possible. This can especially be the case for an employee that has secured another position already, and doesn't want to leave the company before using sick days or vacation days to their fullest extent prior to transitioning to their new position outside the company. A substantial change in hours worked that isn't associated with demographic life changes as discussed with regard to FIG. 4 may be even more indicative of a dissatisfied employee.

Frequency of income 570 can be determined based on the date of receipt of wages, bonuses, payment dates for dividends and other periodic income. In the absence of data that can be used, it can be assumed that the end and the beginning of the month coincides with receipt of wages (e.g., between the 25^{th} day of the month and the 10^{th} day of the following month).

In aggregating the data collected as described with respect to FIGS. 1-5, functions can be established for both an employee satisfaction index 160 and a possible job change index 150. For example, for the employee satisfaction index, the data as collected above can be framed in a scale from −1 indicating complete dissatisfaction, to 0 indicating unpredictability, to 1 indicating complete satisfaction. Similarly, the possibility job change index can be framed in a scale of 0 meaning the employees behavior does not correlate with a potential job change to a 1 meaning a serious risk of the employee changing jobs. Individual data, for each index, can be weighted within the aggregate to address data sets that offer greater predictability than other data sets. When employees leave, or express satisfaction or dissatisfaction in their employment, data can be analyzed to determine how that satisfaction was manifested within the data, further refining the weighting of data sets.

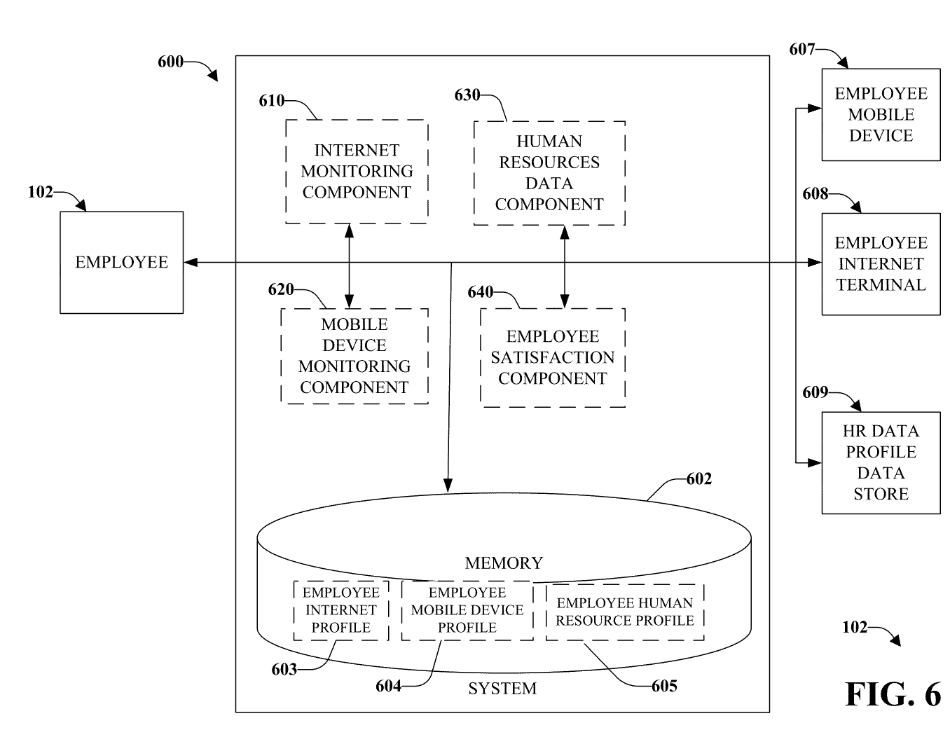

Referring now to FIG. 6, there is illustrated an example system in accordance with implementations of this disclosure. An employee 102 can have access to an employee mobile device 607, an employee internet terminal 608, and have a human resources data profile 605 associated with them stored within human resource data profile data store 609.

An internet monitoring component 610 monitors internet usage data associated with internet usage of an employee and generates employee internet profile data representative of an internet profile of the employee based on a result of the internet usage data being monitored. The internet usage can be associated with employee mobile device 607 or employee internet terminal 608. In one implementation, the internet monitoring component 610 monitors at least one of social network site visits by the employee, social network site posts by the employee, updated resumes in social network sites uploaded by the employee, business e-mail frequency associated with e-mails by the employee, personal e-mail frequency associated with the e-mails by the employee, or university site visits by the employee. The employee internet profile 603 can be stored within memory 602 for access by other components.

A mobile device monitoring component 620 monitors mobile communication data representative of communications associated with a mobile device of the employee and generates employee mobile device profile data representative of an employee mobile device profile based on a result of the mobile communication data being monitored. Mobile traffic can be associated with employee mobile device 607, or employee assigned telecommunication resources that are not mobile. In one implementation, the mobile device monitoring component 620 monitors at least one of a first frequency of calls using the mobile device during work hours defined for the employee, a second frequency of text messages using the mobile device during the work hours, or location log data representative of past locations of the mobile device. The employee mobile device profile 604 can be stored within memory 602 for access by other components.

A human resources data component 630 generates employee human resource profile data representative of a human resource profile of the employee based on job description data representative of a job description of the employee, attendance record data representative of an attendance record of the employee, and compensation profile data representative of a compensation profile of the employee. The human resource profile data can be retrieved from human resource data profile data store 609 and stored within memory 602 for access by other components. An employee satisfaction component 640 determines employee job satisfaction data representative of a job satisfaction of the employee based on the employee internet profile data, the employee mobile device profile data, and the employee human resource profile data.

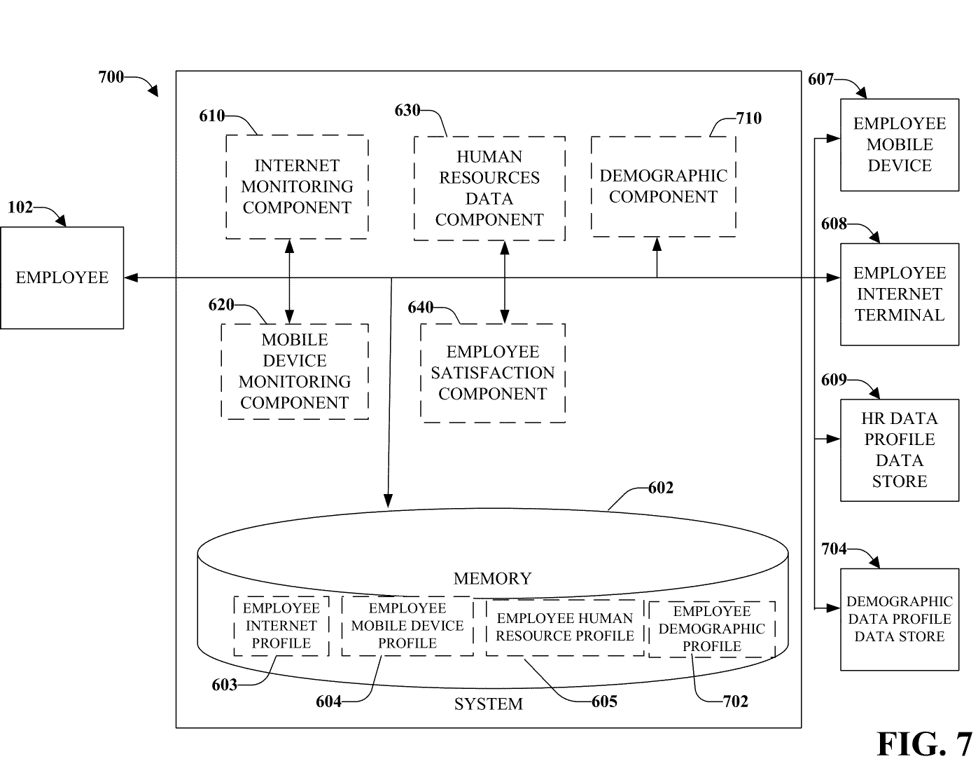

Referring now to FIG. 7, there is illustrated an example system including a demographic component 710 in accordance with implementations of this disclosure. Employee 102 can also have an employee demographic profile 702 associated with them stored within demographic data profile data store 704.

Demographic component 710 generates employee demographic profile data representative of a demographic profile of the employee wherein the employee satisfaction component determines the employee job satisfaction data based on the employee demographic profile data. In one implementation, the employee demographic profile data includes at least one of a home purchase date associated with the employee, a residence change date associated with the employee, a set of child birth dates associated with the employee, a marriage date associated with the employee, a credit report value associated with the employee, or an employee birth date associated with the employee.

In one implementation, the employee satisfaction component 640 component further generates a possible job change predictor value associated with the employee based on the employee internet profile data, the employee mobile device profile data, the employee human resource profile data, and the employee demographic profile data.

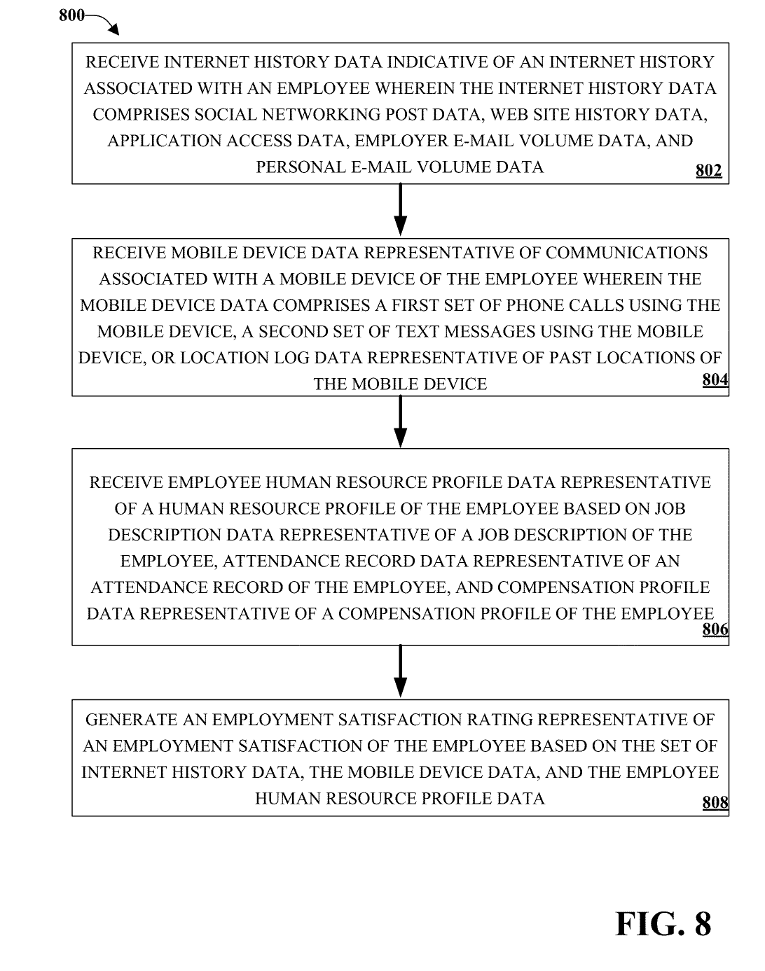

FIGS. 8-13 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

FIG. 8 illustrates an example flow diagram method for generating an employment satisfaction rating in accordance with implementations of this disclosure. At 802, internet history data indicative of an internet history associated with an employee can be received (e.g., by internet monitoring component 610) wherein the internet history data comprises social networking post data, web site history data, application access data, employer e-mail volume data, and personal e-mail volume data. At 804, mobile device data representative of communications associated with a mobile device of the employee can be received (e.g., by a mobile device monitoring component 620) wherein the mobile device data comprises a first set of phone calls using the mobile device, a second set of text messages using the mobile device, or location log data representative of past locations of the mobile device. At 806, employee human resource profile data representative of a human resource profile of the employee can be received (e.g., by human resources data component) wherein the employee human resource profile is based on job description data representative of a job description of the employee, attendance record data representative of an attendance record of the employee, and compensation profile data representative of a compensation profile of the employee. At 808, an employment satisfaction rating can be generated (e.g., by an employment satisfaction component 640) for the employee based on the set of internet history data, the mobile device data, and the employee human resource profile data.

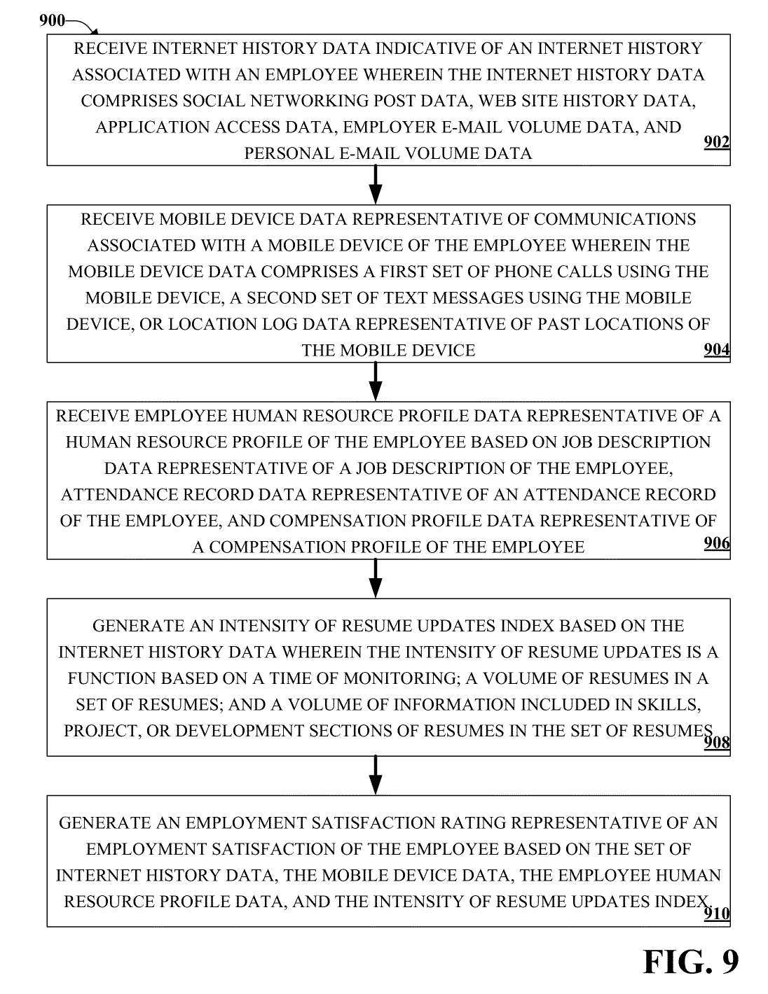

FIG. 9 illustrates an example flow diagram method for generating an employment satisfaction including generating an intensity of resume update index in accordance with implementations of this disclosure. At 902, internet history data indicative of an internet history associated with an employee can be received (e.g., by internet monitoring component 610) wherein the internet history data comprises social networking post data, web site history data, application access data, employer e-mail volume data, and personal e-mail volume data. At 904, mobile device data representative of communications associated with a mobile device of the employee can be received (e.g., by a mobile device monitoring component 620) wherein the mobile device data comprises a first set of phone calls using the mobile device, a second set of text messages using the mobile device, or location log data representative of past locations of the mobile device. At 906, employee human resource profile data representative of a human resource profile of the employee can be received (e.g., by human resources data component) wherein the employee human resource profile is based on job description data representative of a job description of the employee, attendance record data representative of an attendance record of the employee, and compensation profile data representative of a compensation profile of the employee.

At 908, an intensity of resume updates index can be generated based on the internet history data wherein the intensity of resume updates is a function based on a time of monitoring; a volume of resumes in a set of resumes; and a volume of information included in skills, project, or development sections of resumes in the set of resumes. At 910, an employment satisfaction rating can be generated (e.g., by an employment satisfaction component 640) for the employee based on the set of internet history data, the mobile device data, the employee human resource profile data and the intensity of resume updates index.

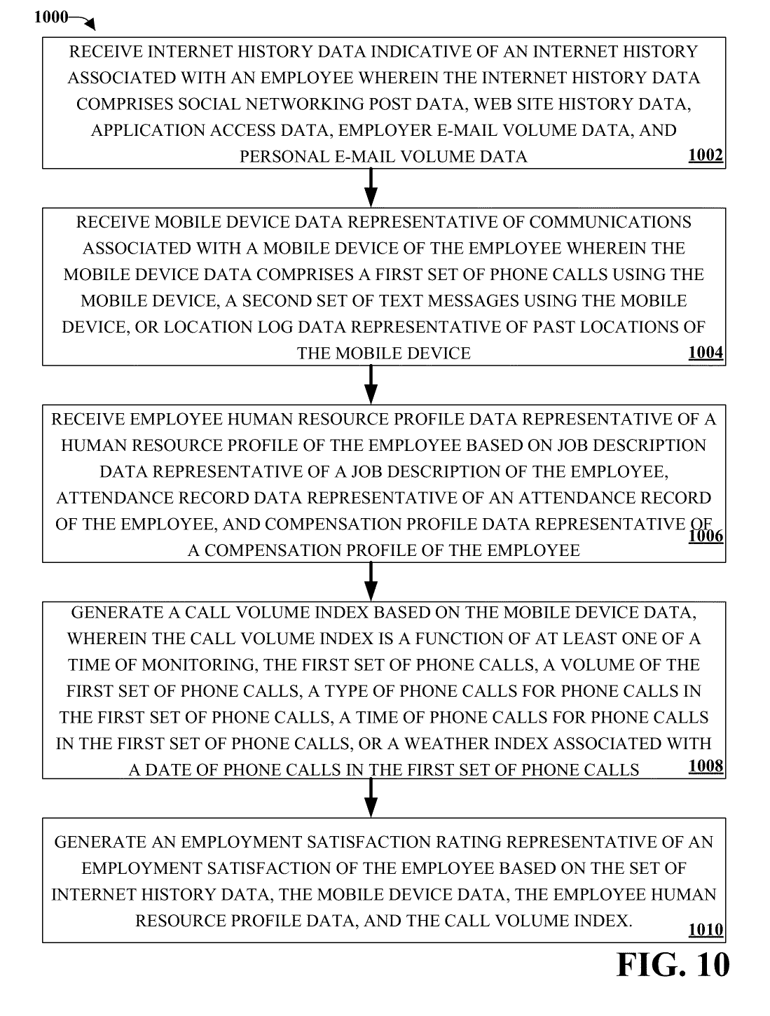

FIG. 10 illustrates an example flow diagram method for generating an employment satisfaction rating including generating a call volume index in accordance with implementations of this disclosure. At 1002, internet history data indicative of an internet history associated with an employee can be received (e.g., by internet monitoring component 610) wherein the internet history data comprises social networking post data, web site history data, application access data, employer e-mail volume data, and personal e-mail volume data. At 1004, mobile device data representative of communications associated with a mobile device of the employee can be received (e.g., by a mobile device monitoring component 620) wherein the mobile device data comprises a first set of phone calls using the mobile device, a second set of text messages using the mobile device, or location log data representative of past locations of the mobile device. At 1006, employee human resource profile data representative of a human resource profile of the employee can be received (e.g., by human resources data component) wherein the employee human resource profile is based on job description data representative of a job description of the employee, attendance record data representative of an attendance record of the employee, and compensation profile data representative of a compensation profile of the employee.

At 1008, a call volume index can be generated based on the mobile device data wherein the call volume index is a function based on a time of monitoring, the first set of phone calls, a volume of the first set of phone calls, a type of phone calls for phone calls in the first set of phone calls, a time of phone calls for phone calls in the first set of phone calls, and a weather index associated with a date of phone calls in the first set of phone calls. In one implementation, in response to determining the time of phone calls associated with a phone call among the first set of phone calls is outside of a work schedule associated with the employee, the phone call is removed from the first set of phone calls. At 1010, an employment satisfaction rating can be generated (e.g., by an employment satisfaction component 640) for the employee based on the set of internet history data, the mobile device data, the employee human resource profile data and the call volume index.

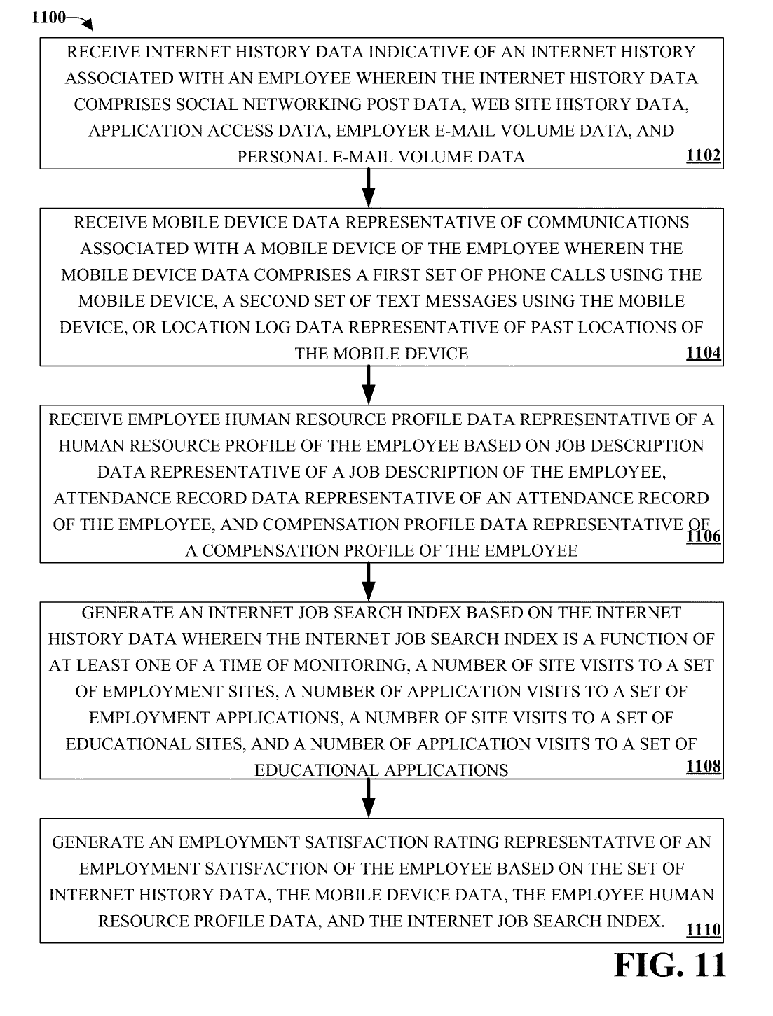

FIG. 11 illustrates an example flow diagram method for generating an employment satisfaction rating including generating an internet job search index in accordance with implementations of this disclosure. At 1102, internet history data indicative of an internet history associated with an employee can be received (e.g., by internet monitoring component 610) wherein the internet history data comprises social networking post data, web site history data, application access data, employer e-mail volume data, and personal e-mail volume data. At 1104, mobile device data representative of communications associated with a mobile device of the employee can be received (e.g., by a mobile device monitoring component 620) wherein the mobile device data comprises a first set of phone calls using the mobile device, a second set of text messages using the mobile device, or location log data representative of past locations of the mobile device. At 1106, employee human resource profile data representative of a human resource profile of the employee can be received (e.g., by human resources data component) wherein the employee human resource profile is based on job description data representative of a job description of the employee, attendance record data representative of an attendance record of the employee, and compensation profile data representative of a compensation profile of the employee.

At 1108, an internet job search index can be generated based on the internet history data wherein the internet job search index is a function of at least one of a time of monitoring, a number of site visits to a set of employment sites, a number of application visits to a set of employment applications, a number of site visits to a set of educational sites, and a number of application visits to a set of educational applications. At 1110, an employment satisfaction rating can be generated (e.g., by an employment satisfaction component 640) for the employee based on the set of internet history data, the mobile device data, the employee human resource profile data and the internet job search index.

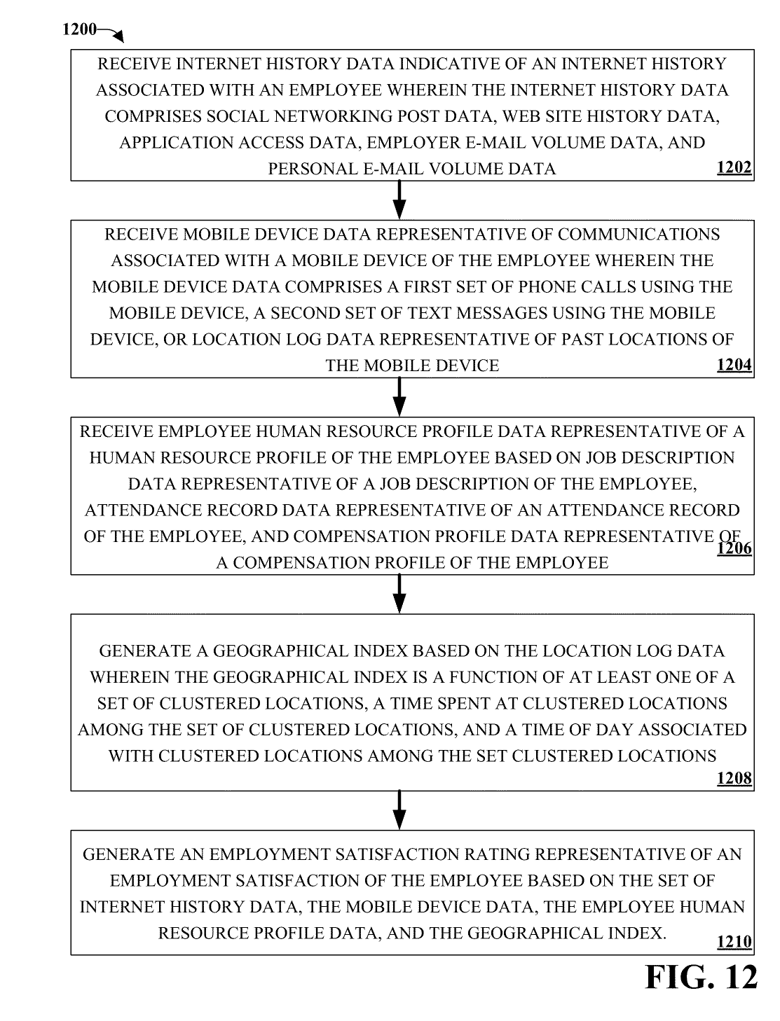

FIG. 12 illustrates an example flow diagram method for generating an employment satisfaction rating including generating a geographical index in accordance with implementations of this disclosure. At 1202, internet history data indicative of an internet history associated with an employee can be received (e.g., by internet monitoring component 610) wherein the internet history data comprises social networking post data, web site history data, application access data, employer e-mail volume data, and personal e-mail volume data. At 1204, mobile device data representative of communications associated with a mobile device of the employee can be received (e.g., by a mobile device monitoring component 620) wherein the mobile device data comprises a first set of phone calls using the mobile device, a second set of text messages using the mobile device, or location log data representative of past locations of the mobile device. At 1206, employee human resource profile data representative of a human resource profile of the employee can be received (e.g., by human resources data component) wherein the employee human resource profile is based on job description data representative of a job description of the employee, attendance record data representative of an attendance record of the employee, and compensation profile data representative of a compensation profile of the employee.

At 1208, a geographical index can be based on the location log data wherein the geographical index is a function of at least one of a set of clustered locations, a time spent at clustered locations among the set of clustered locations, and a time of day associated with clustered locations among the set clustered locations. In one implementation, the geographical index further indicates an emergence of a new geographical location. At 1210, an employment satisfaction rating can be generated (e.g., by an employment satisfaction component 640) for the employee based on the set of internet history data, the mobile device data, the employee human resource profile data and the geographical index.

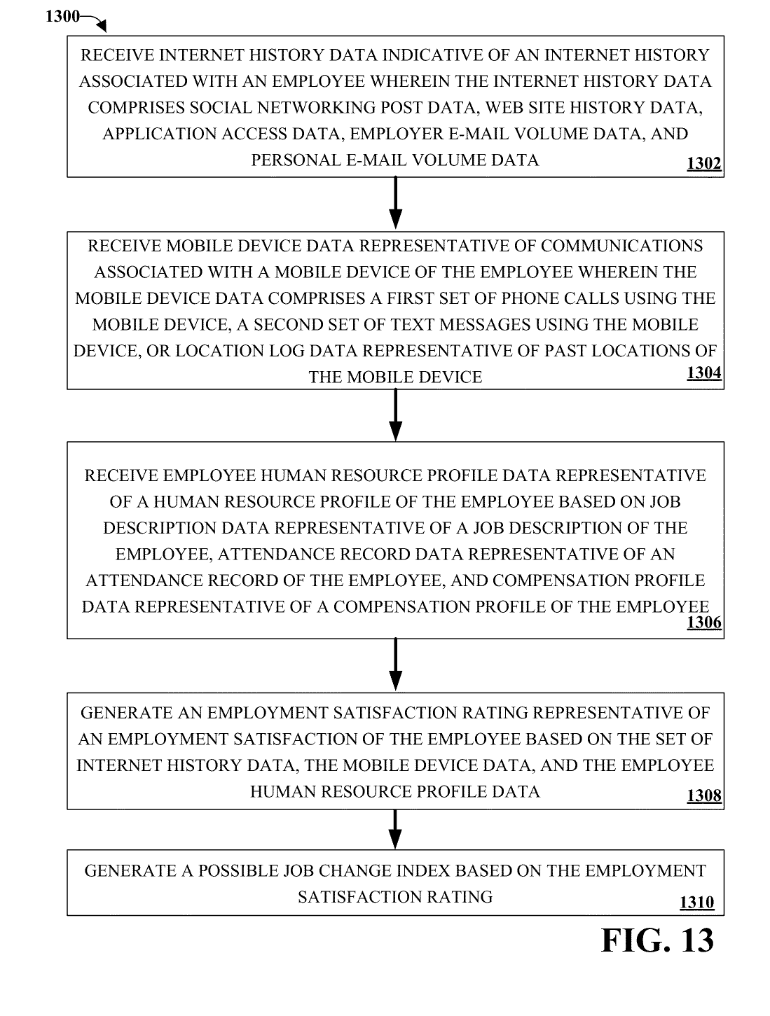

FIG. 13 illustrates an example flow diagram method for generating an employment satisfaction rating including generating a possible job change index in accordance with implementations of this disclosure. At 1302, internet history data indicative of an internet history associated with an employee can be received (e.g., by internet monitoring component 610) wherein the internet history data comprises social networking post data, web site history data, application access data, employer e-mail volume data, and personal e-mail volume data. At 1304, mobile device data representative of communications associated with a mobile device of the employee can be received (e.g., by a mobile device monitoring component 620) wherein the mobile device data comprises a first set of phone calls using the mobile device, a second set of text messages using the mobile device, or location log data representative of past locations of the mobile device. At 1306, employee human resource profile data representative of a human resource profile of the employee can be received (e.g., by human resources data component) wherein the employee human resource profile is based on job description data representative of a job description of the employee, attendance record data representative of an attendance record of the employee, and compensation profile data representative of a compensation profile of the employee.

At 1308, an employment satisfaction rating can be generated (e.g., by an employment satisfaction component 640) for the employee the internet history data, the mobile device data, and the employee human resource profile data. At 1310, a possible job change index can be generated (e.g., by an employment satisfaction component 640) based on the employment satisfaction rating. In one implantation, the possible job change index is further based on the internet history data, the mobile device data, and the employee human resource profile data.

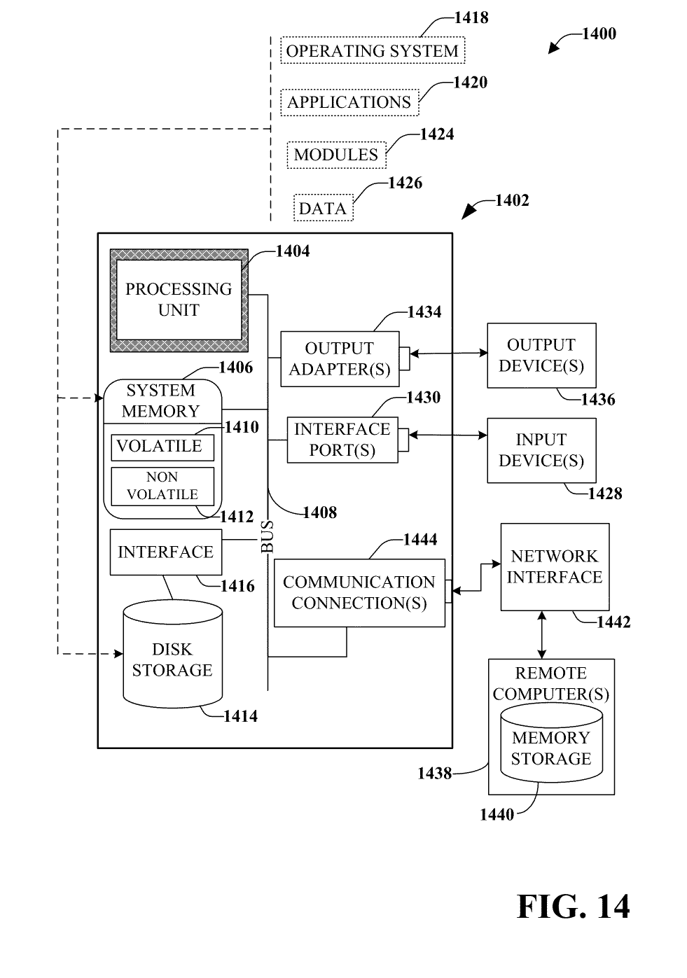

With reference to FIG. 14, a suitable environment 1400 for implementing various aspects of the claimed subject matter includes a computer 1402. The computer 1402 includes a processing unit 1404, a system memory 1406, and a system bus 1408. The system bus 1408 couples system components including, but not limited to, the system memory 1406 to the processing unit 1404. The processing unit 1404 can be any of various available processors. Dual microprocessors and other multiprocessor architectures also can be employed as the processing unit 1404.

The system bus 1408 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1406 includes volatile memory 1410 and non-volatile memory 1412. The basic input/output system (BIOS), containing the basic routines to transfer information between elements within the computer 1402, such as during start-up, is stored in non-volatile memory 1412. By way of illustration, and not limitation, non-volatile memory 1412 can include read only memory (ROM), programmable ROM (PROM), electrically programmable ROM (EPROM), electrically erasable programmable ROM (EEPROM), or flash memory. Volatile memory 1410 includes random access memory (RAM), which acts as external cache memory. According to present aspects, the volatile memory may store the write operation retry logic (not shown in FIG. 14) and the like. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM).

Computer 1402 may also include removable/non-removable, volatile/non-volatile computer storage media. FIG. 14 illustrates, for example, a disk storage 1414. Disk storage 1414 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1414 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1414 to the system bus 1408, a removable or non-removable interface is typically used, such as interface 1416.

It is to be appreciated that FIG. 14 describes software that acts as an intermediary between users and the basic computer resources described in the suitable operating environment 1400. Such software includes an operating system 1418. Operating system 1418, which can be stored on disk storage 1414, acts to control and allocate resources of the computer system 1402. Applications 1420 take advantage of the management of resources by operating system 1418 through program modules 1424, and program data 1426, such as the boot/shutdown transaction table and the like, stored either in system memory 1406 or on disk storage 1414. It is to be appreciated that the claimed subject matter can be implemented with various operating systems or combinations of operating systems.

A user enters commands or information into the computer 1402 through input device(s) 1428. Input devices 1428 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1404 through the system bus 1408 via interface port(s) 1430. Interface port(s) 1430 include, for example, a serial port, a parallel port, a game port, and a universal serial bus (USB). Output device(s) 1436 use some of the same type of ports as input device(s) 1428. Thus, for example, a USB port may be used to provide input to computer 1402, and to output information from computer 1402 to an output device 1436. Output adapter 1434 is provided to illustrate that there are some output devices 1436 like monitors, speakers, and printers, among other output devices 1436, which require special adapters. The output adapters 1434 include, by way of illustration and not limitation, video and sound cards that provide a means of connection between the output device 1436 and the system bus 1408. It should be noted that other devices and/or systems of devices provide both input and output capabilities such as remote computer(s) 1438.

Computer 1402 can operate in a networked environment using logical connections to one or more remote computers, such as remote computer(s) 1438. The remote computer(s) 1438 can be a personal computer, a bank server, a bank client, a bank processing center, a certificate authority, a router, a network PC, a workstation, a microprocessor based appliance, a peer device, a smart phone, a tablet, or other network node, and typically includes many of the elements described relative to computer 1402. For purposes of brevity, only a memory storage device 1440 is illustrated with remote computer(s) 1438. Remote computer(s) 1438 is logically connected to computer 1402 through a network interface 1442 and then connected via communication connection(s) 1444. Network interface 1442 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1444 refers to the hardware/software employed to connect the network interface 1442 to the bus 1408. While communication connection 1444 is shown for illustrative clarity inside computer 1402, it can also be external to computer 1402. The hardware/software necessary for connection to the network interface 1442 includes, for exemplary purposes only, internal and external technologies such as, modems including regular telephone grade modems, cable modems and DSL modems, ISDN adapters, and wired and wireless Ethernet cards, hubs, and routers.

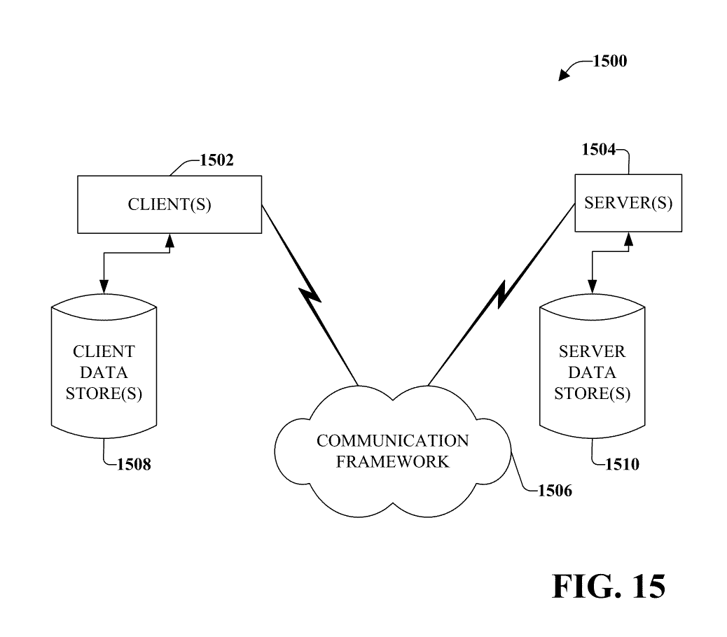

Referring now to FIG. 15, there is illustrated a schematic block diagram of a computing environment 1500 in accordance with the subject specification. The system 1500 includes one or more client(s) 1502, which can include an application or a system that accesses a service on the server 1504. The client(s) 1502 can be hardware and/or software (e.g., threads, processes, computing devices). The client(s) 1502 can house cookie(s) and/or associated contextual information by employing the specification, for example.

The system 1500 also includes one or more server(s) 1504. The server(s) 1504 can also be hardware or hardware in combination with software (e.g., threads, processes, computing devices). The servers 1504 can house threads to perform, for example, identifying morphological features, extracting meaning, auto generating FAQs, ranking, etc. One possible communication between a client 1502 and a server 1504 can be in the form of a data packet adapted to be transmitted between two or more computer processes where the data packet contains, for example, a certificate. The data packet can include a cookie and/or associated contextual information, for example. The system 1500 includes a communication framework 1506 (e.g., a global communication network such as the Internet) that can be employed to facilitate communications between the client(s) 1502 and the server(s) 1504.

Communications can be facilitated via a wired (including optical fiber) and/or wireless technology. The client(s) 1502 are operatively connected to one or more client data store(s) 1508 that can be employed to store information local to the client(s) 1502 (e.g., cookie(s) and/or associated contextual information). Similarly, the server(s) 1504 are operatively connected to one or more server data store(s) 1510 that can be employed to store information local to the servers 1504.

The illustrated aspects of the disclosure may also be practiced in distributed computing environments where certain tasks are performed by remote processing devices that are linked through a communications network. In a distributed computing environment, program modules can be located in both local and remote memory storage devices.

The processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

What has been described above includes examples of the implementations of the present invention. It is, of course, not possible to describe every conceivable combination of components or methods for purposes of describing the claimed subject matter, but many further combinations and permutations of the subject embodiments are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the various embodiments includes a system as well as a computer-readable storage medium having computer-executable instructions for performing the acts and/or events of the various methods of the claimed subject matter.

What is claimed is:

1. A system, comprising:
a memory that stores computer executable components; and
a processor, communicatively coupled to the memory, that facilitates execution of computer executable components, the computer executable components comprising:
an internet monitoring component that monitors internet usage data associated with internet usage of an employee and generates employee internet profile data representative of an internet profile of the employee based on a result of the internet usage data being monitored;
a mobile device monitoring component that monitors mobile communication data representative of communications associated with a mobile device of the employee and generates employee mobile device profile data representative of an employee mobile device profile based on a result of the mobile communication data being monitored;
a human resources data component that generates employee human resource profile data representative of a human resource profile of the employee based on job description data representative of a job description of the employee, attendance record data representative of an attendance record of the employee, and compensation profile data representative of a compensation profile of the employee; and
an employee satisfaction component that determines employee job satisfaction data representative of a job satisfaction of the employee based on the employee internet profile data, the employee mobile device profile data, and the employee human resource profile data.

2. The system of claim 1, wherein the computer executable components further comprise:
a demographic component that generates employee demographic profile data representative of a demographic profile of the employee wherein the employee satisfaction component determines the employee job satisfaction data based on the employee demographic profile data.

3. The system of claim 2, wherein the employee demographic profile data includes at least one of a home purchase date associated with the employee, a residence change date associated with the employee, a set of child birth dates associated with the employee, a marriage date associated with the employee, a credit report value associated with the employee, or an employee birth date associated with the employee.

4. The system of claim 1, wherein the internet monitoring component monitors at least one of social network site visits by the employee, social network site posts by the employee, updated resumes in social network sites uploaded by the employee, business e-mail frequency associated with e-mails by the employee, personal e-mail frequency associated with the e-mails by the employee, or university site visits by the employee.

5. The system of claim 1, wherein the mobile device monitoring component monitors at least one of a first frequency of calls using the mobile device during work hours defined for the employee, a second frequency of text messages using the mobile device during the work hours, or location log data representative of past locations of the mobile device.

6. The system of claim 2, wherein the employee satisfaction component further generates a possible job change predictor value associated with the employee based on the employee internet profile data, the employee mobile device profile data, the employee human resource profile data, and the employee demographic profile data.

7. A method, comprising:
receiving, by a system including a processor, internet history data indicative of an internet history associated with an employee wherein the internet history data comprises social networking post data, web site history data, application access data, employer e-mail volume data, and personal e-mail volume data;
receiving mobile device data representative of communications associated with a mobile device of the employee wherein the mobile device data comprises a first set of phone calls using the mobile device, a second set of text messages using the mobile device, or location log data representative of past locations of the mobile device;
receiving employee human resource profile data representative of a human resource profile of the employee based on job description data representative of a job description of the employee, attendance record data representative of an attendance record of the employee, and compensation profile data representative of a compensation profile of the employee;
generating an employment satisfaction rating representative of an employment satisfaction of the employee based on the set of internet history data, the mobile device data, and the employee human resource profile data.

8. The method of claim 7, further comprising:
generating an intensity of resume updates index based on the internet history data wherein the intensity of resume updates is a function based on a time of monitoring, a volume of resumes in a set of resumes, and a volume of information included in skills, project, or development sections of resumes in the set of resumes.

9. The method of claim 8, wherein the generating the employment satisfaction rating is based on the intensity of resume updates index.

10. The method of claim 7, further comprising:
generating a call volume index based on the mobile device data, wherein the call volume index is a function of at least one of a time of monitoring, the first set of phone calls, a volume of the first set of phone calls, a type of phone calls for phone calls in the first set of phone calls, a time of phone calls for phone calls in the first set of phone calls, or a weather index associated with a date of phone calls in the first set of phone calls.

11. The method of claim 10, further comprising, in response to determining the time of phone calls associated with a phone call among the first set of phone calls is outside of a work schedule associated with the employee, removing the phone call from the first set of phone calls.

12. The method of claim 10, wherein the generating the employment satisfaction rating is based on the call volume index.

13. The method of claim 7, further comprising:
generating an internet job search index based on the internet history data, wherein the internet job search index is a function of at least one of a time of monitoring, a number of site visits to a set of employment sites, a number of application visits to a set of employment applications, a number of site visits to a set of educational sites, or a number of application visits to a set of educational applications.

14. The method of claim 13, wherein the generating the employment satisfaction rating is based on the internet job search index.

15. The method of claim 7, further comprising:
generating a geographical index based on the location log data, wherein the geographical index is a function of at least one of a set of clustered locations, a time spent at clustered locations among the set of clustered locations, or a time of day associated with clustered locations among the set clustered locations.

16. The method of claim 15, wherein the generating the employment satisfaction rating is based on the geographical index.

17. The method of claim 15, wherein the geographical index further indicates an emergence of a new geographical location.

18. The method of claim 7, further comprising:
generating a possible job change index based on the employment satisfaction rating.

19. The method of claim 18, wherein the generating the possible job change index is based on the internet history data, the mobile device data, and the employee human resource profile data.

20. A system, comprising:
means for receiving internet history data indicative of an internet history associated with an employee wherein the internet history data comprises social networking post data, web site history data, application access data, employer e-mail volume data, and personal e-mail volume data;
means for mobile device data representative of communications associated with a mobile device of the employee wherein the mobile device data comprises a first set of phone calls using the mobile device, a second set of text messages using the mobile device, or location log data representative of past locations of the mobile device;
means for employee human resource profile data representative of a human resource profile of the employee based on job description data representative of a job description of the employee, attendance record data representative of an attendance record of the employee; and
means for generating an employment satisfaction rating representative of an employment satisfaction of the employee based on the set of internet history data, the mobile device data, and the employee human resource profile data.

21. The system of claim 20, further comprising:
means for generating a possible job change index based on the employment satisfaction rating, the internet history data, the mobile device data, and the employee human resource profile data.

22. The system of claim 20, further comprising:
means for generating an intensity of resume updates index based on the internet history data, wherein the intensity of resume updates is a function based on a time of monitoring, a volume of resumes in a set of resumes, and a volume of information included in skills, project, or development sections of resumes in the set of resumes, and wherein the means for generating the employment satisfaction rating generates the employment satisfaction rating based on the intensity of resume updates index.

23. A computer-readable storage medium comprising computer-executable instructions that, in response to execution, cause a computing system comprising a processor to perform operations, comprising:
receiving internet history data indicative of an internet history associated with an employee, wherein the internet history data comprises social networking post data, web site history data, application access data, employer e-mail volume data, and personal e-mail volume data;
receiving mobile device data representative of communications associated with a mobile device of the employee wherein the mobile device data comprises a first set of phone calls using the mobile device, a second set of text messages using the mobile device, or location log data representative of past locations of the mobile device;
receiving employee human resource profile data representative of a human resource profile of the employee based on job description data representative of a job description of the employee, attendance record data representative of an attendance record of the employee, and compensation profile data representative of a compensation profile of the employee;
receiving demographic profile data representative of a demographic profile of the employee based on at least one of a home purchase date associated with the employee, a residence change date associated with the employee, a set of child birth dates associated with the employee, a marriage date associated with the employee, a credit report value associated with the employee, or an employee birth date associated with the employee; and
generating an employment satisfaction rating representative of an employment satisfaction of the employee based on the set of internet history data, the mobile device data, the employee human resource profile data; and the demographic profile data.

24. The computer-readable storage medium of claim 23, further comprising:
generating a possible job change index based on the employment satisfaction rating, the internet history data, the mobile device data, the employee human resource profile data, and the demographic profile data.

25. The computer-readable storage medium of claim 23, wherein internet history data includes data from the mobile device of the employee.
